(19) United States
(12) Patent Application Publication
(10) Pub. No.: US 2024/0005653 A1
(43) Pub. Date: Jan. 4, 2024

(54) Systems and Methods for Tool Canvas Metadata & Auto-Configuration in Machine Vision Applications

(71) Applicant: ZEBRA TECHNOLOGIES CORPORATION, Lincolnshire, IL (US)

(72) Inventors: Matthew M. Degen, Ridge, NY (US); James Matthew Witherspoon, Howell, MI (US); Brian S. Robertson, Harrisburg, PA (US); Matthew A. Russo, Middle Island, NY (US)

(21) Appl. No.: 17/956,469

(22) Filed: Sep. 29, 2022

Related U.S. Application Data
(60) Provisional application No. 63/357,504, filed on Jun. 30, 2022.

(51) Int. Cl. G06V 10/94; G06V 10/25; G06V 10/22; G06V 10/24; G06V 10/44

(52) U.S. Cl. CPC G06V 10/945; G06V 10/25; G06V 10/235; G06V 10/248; G06V 10/44; G06V 2201/07

(57) ABSTRACT

Example systems and methods for auto-configuring a tool for one or more imaging device jobs are disclosed. An example system includes a machine vision camera, and a client computing device coupled thereto. The client computing device, operating in a build mode, is configured to: receive an image; present the image on a canvas, wherein the canvas is part of a user interface of a machine vision application; display targets of interest in the canvas based on a machine vision tool; upon selection of a target, determine corresponding metadata elements for the target and automatically reconfigure the tool to identify targets corresponding to those metadata elements or to a range thereof. The reconfigured tool is then deployed for runtime operation.

### CROSS-REFERENCE TO RELATED APPLICATIONS

This application claims priority to U.S. Provisional Application No. 63/357,504, filed Jun. 30, 2022, which is incorporated herein by reference in its entirety.

### FIELD OF THE DISCLOSURE

This disclosure relates generally to machine vision applications, and, more particularly, to systems and methods for auto-configuration of tool canvas metadata in machine vision applications.

### BACKGROUND

Over the years, industrial automation has come to rely heavily on machine vision components capable of assisting operators in a wide variety of tasks. In some implementations, machine vision components, like cameras, are utilized to track objects, like those which move on a conveyor belt past stationary cameras. Often, these cameras (also referred to as Imaging devices) interface with client devices (e.g., personal computers) which run corresponding applications operable to interact with these imaging devices at a wide variety of levels. In these applications, image manipulation and analysis is often routine and includes user interaction through the use of multiple regions of interest (ROIs) within those images. However, the image analysis can be time consuming, requiring manual processes of the operator. For example, applications exist to identify objects in captured images. Often a user will want to view metadata about a specific type of object and to count or otherwise label objects similar to that identified object. However, some applications have tools that allow for filtering the object(s) based on features. These features can be adjusted to narrow the search to only objects of a certain size and shape, for example. However, such operation is a manual process that can be time consuming, requiring a user to manually identify objects based on the metadata.

There is a need for a simpler way to view resultant metadata of an image and filter unwanted from wanted results.

### SUMMARY

In an embodiment, a method for auto-configuring a tool for one or more imaging device jobs is provided. The method comprises: displaying, by one or more processors via a display screen, an interactive graphical user interface (GUI) of an application, the application configured to generate job runs for the imaging devices in a job edit mode; displaying, by the one or more processors within the interactive GUI, an image; detecting, by the one or more processors, a selection of a region of interest (ROI) of the image; analyzing, by the one or more processors, the ROI of the image using a tool to identify one or more targets in the image based on tool configuration parameters of the tool; selecting a target among the one or more targets in the image and displaying user-selectable image metadata elements and result values of each element corresponding to the selected target; selecting one or more user-selectable image metadata elements; adjusting the tool configuration based on the user-selectable image metadata elements to generate revised tool configuration parameters for the tool; and re-analyzing and displaying the ROI of the image using the tool with the revised tool configuration.

In variations of this embodiment, the method further includes revising the job to include the tool with revised tool configuration; and deploying the revised job to the imaging device for execution during a job runtime mode.

In variations of this embodiment, each of the user-selectable image metadata elements corresponds to a different element in the tool configuration.

In variations of this embodiment, adjusting the tool configuration based on the user-selectable image metadata elements comprises: for each selected one or more user-selectable image metadata elements applying an auto-configuration parameter to automatic adjust the tool configuration.

In variations of this embodiment, the auto-configuration parameter is a percentage range parameter or a binary parameter.

In variations of this embodiment, the auto-configuration parameter represents a combination of auto-configuration parameters, each for revising a different element of the tool configuration.

In variations of this embodiment, method further comprises for each of the one or more user-selectable image metadata elements displaying a current parameter value corresponding to the one or more targets and displaying a user selection button.

In variations of this embodiment, the tool is a blob detection tool, and wherein analyzing the ROI of the image using the tool to identify the one or more targets in the image comprises: identifying, as the one or more targets, uniform blobs of pixel intensity or pixel color.

In variations of this embodiment, the one more user-selectable image metadata elements are selected from the group consisting of area, major axis length, and minor axis length.

In variations of this embodiment, the tool configuration of the blob detection tool comprising area, major axis length, and minor axis length, axis, center X-axis position, and center Y-axis position.

In variations of this embodiment, the tool is a barcode detection tool, and wherein analyzing the ROI of the image using the tool to identify the one or more targets in the image comprises: identifying, as the one or more targets, one or more barcodes in the image.

In variations of this embodiment, the one or more user-selectable image metadata elements comprises a barcode symbology type or a barcode percentage overlap in the ROI.

In variations of this embodiment, the tool is an edge detection tool, and wherein analyzing the ROI of the image using the tool to identify the one or more targets in the image comprises: identifying, as the one or more targets, one or more edges in the image.

In variations of this embodiment, the one or more user-selectable image metadata elements comprises an edge angel, edge length, or edge polarity.

In another embodiment, a system for auto-configuring a tool for one or more imaging device jobs is provided. The system comprises a machine vision camera. The system further comprises a client computing device coupled to the machine vision camera, wherein the client computing device is configured to: display, by one or more processors via a display screen, an interactive graphical user interface (GUI) of an application, the application configured to generate job runs for the imaging devices in a job edit mode; display, by the one or more processors within the interactive GUI, an image; detect, by the one or more processors, a selection of a region of interest (ROI) of the image; analyze, by the one or more processors, the ROI of the image using a tool to identify one or more targets in the image based on tool configuration parameters of the tool; select a target among the one or more targets in the image and display user-selectable image metadata elements and result values of each element corresponding to the selected target; select one or more user-selectable image metadata elements; adjust the tool configuration based on the user-selectable image metadata elements to generate revised tool configuration parameters for the tool; and re-analyze and display the ROI of the image using the tool with the revised tool configuration.

In variations of this embodiment, the client computing device is further configured to: revise the job to include the tool with revised tool configuration; and deploy the revised job to the imaging device for execution during a job runtime mode.

In variations of this embodiment, each of the user-selectable image metadata elements corresponds to a different element in the tool configuration.

In variations of this embodiment, the client computing device is further configured to adjust the tool configuration based on the user-selectable image metadata elements by: for each selected one or more user-selectable image metadata elements applying an auto-configuration parameter to automatic adjust the tool configuration.

In variations of this embodiment, the auto-configuration parameter is a percentage range parameter or a binary parameter.

In variations of this embodiment, the auto-configuration parameter represents a combination of auto-configuration parameters, each for revising a different element of the tool configuration.

In variations of this embodiment, the client computing device is further configured to for each of the one or more user-selectable image metadata elements display a current parameter value corresponding to the one or more targets and displaying a user selection button.

In variations of this embodiment, the tool is a blob detection tool, and wherein the client computing device is further configured to analyze the ROI of the image using the tool to identify the one or more targets in the image by: identifying, as the one or more targets, uniform blobs of pixel intensity or pixel color.

In variations of this embodiment, the one more user-selectable image metadata elements are selected from the group consisting of area, major axis length, and minor axis length.

In variations of this embodiment, the tool configuration of the blob detection tool comprising area, major axis length, and minor axis length, axis, center X-axis position, and center Y-axis position.

In variations of this embodiment, the tool is a barcode detection tool, and wherein the client computing device is further configured to analyze the ROI of the image using the tool to identify the one or more targets in the image by: identifying, as the one or more targets, one or more barcodes in the image.

In variations of this embodiment, the one or more user-selectable image metadata elements comprises a barcode symbology type or a barcode percentage overlap in the ROI

In variations of this embodiment, the tool is an edge detection tool, and wherein the client computing device is further configured to analyze the ROI of the image using the tool to identify the one or more targets in the image comprises: identifying, as the one or more targets, one or more edges in the image.

In variations of this embodiment, the one or more user-selectable image metadata elements comprises an edge angel, edge length, or edge polarity.

In yet another embodiment, a non-transitory machine-readable storage medium stores instructions that, when executed by one or more processors, cause a client computing device to: display, by one or more processors via a display screen, an interactive graphical user interface (GUI) of an application, the application configured to generate job runs for the imaging devices in a job edit mode; display, by the one or more processors within the interactive GUI, an image;

detect, by the one or more processors, a selection of a region of interest (ROI) of the image; analyze, by the one or more processors, the ROI of the image using a tool to identify one or more targets in the image based on tool configuration parameters of the tool; select a target among the one or more targets in the image and display user-selectable image metadata elements and result values of each element corresponding to the selected target; select one or more user-selectable image metadata elements; adjust the tool configuration based on the user-selectable image metadata elements to generate revised tool configuration parameters for the tool; and re-analyze and display the ROI of the image using the tool with the revised tool configuration.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments. The figures depict embodiments of this disclosure for purposes of illustration only. One skilled in the art will readily recognize from the following discussion that alternate embodiments of the systems and methods illustrated herein may be employed without departing from the principles set forth herein.

FIG. 1 is an example system for optimizing one or more imaging settings for a machine vision job, in accordance with embodiments described herein.

FIG. 2 is a perspective view of the imaging device of FIG. 1, in accordance with embodiments described herein.

FIG. 3 depicts example application interface utilized in connection with the operation of a machine vision system, in accordance with embodiments described herein.

FIG. 4 is a flowchart representative of an example method, hardware logic, machine-readable instructions, or software for implementing the example user computing device of FIG. 1, in accordance with disclosed embodiments.

FIG. 5 depicts the example application interface of FIG. 4 resulting from processes in the flowchart of FIG. 4 for auto-configuring a Blob tool, in accordance with disclosed embodiments.

FIG. 6 depicts the example application interface of FIG. 4 resulting from further processes in the flowchart of FIG. 4 for auto-configuring a Blob tool, in accordance with disclosed embodiments.

FIG. 7 depicts the example application interface of FIG. 4 resulting from yet further processes in the flowchart of FIG. 4 for auto-configuring a Blob tool, in accordance with disclosed embodiments.

FIG. 8 depicts the example application interface of FIG. 4 resulting from yet further processes in the flowchart of FIG. 4 for auto-configuring a Blob tool, in accordance with disclosed embodiments.

FIG. 9 depicts the example application interface of FIG. 4 showing auto-configurable decode parameters of a Barcode Detection Tool, in accordance with disclosed embodiments.

FIG. 10 depicts the example application interface of FIG. 4 showing auto-configurable advanced parameters of a Barcode Detection Tool, in accordance with disclosed embodiments.

FIG. 11 depicts the example application interface of FIG. 4 showing auto-configurable symbology parameters of a Barcode Detection Tool, in accordance with disclosed embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

Apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Connecting lines or connectors shown in the various figures presented are intended to represent example functional relationships and/or physical or logical couplings between the various elements.

### DETAILED DESCRIPTION

Reference will now be made in detail to non-limiting examples, some of which are illustrated in the accompanying drawings.

### Imaging System

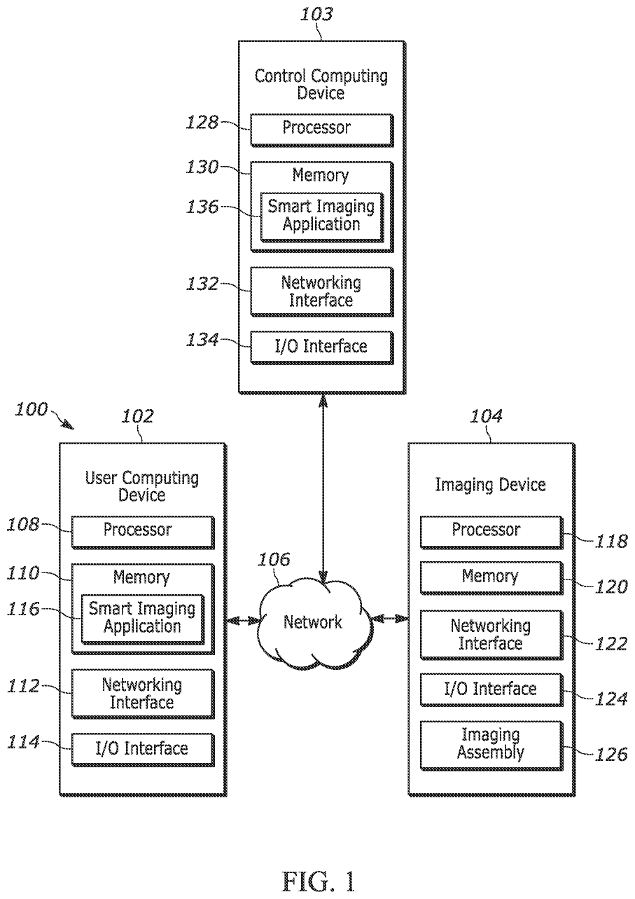

FIG. 1 illustrates an example imaging system 100 configured to analyze pixel data of one or more images of a target object to execute a machine vision job, in accordance with various embodiments disclosed herein. In the example embodiment of FIG. 1, the imaging system 100 includes a user computing device 102 (e.g., a computer, mobile device, a tablet, etc.), a control computing device 103 (e.g., a programmable logic controller (PLC), etc.), and an imaging device 104 communicatively coupled to the user computing device 102 and the control computing device 103 via a network 106. Generally speaking, the user computing device 102 and the imaging device 104 may be capable of executing instructions to, for example, implement operations of the example methods described herein, as may be represented by the flowcharts of the drawings that accompany this description. The user computing device 102 is generally configured to enable a user/operator to create a machine vision job for execution on the imaging device 104. When created, the user/operator may then transmit/upload the machine vision job to the imaging device 104 via the network 106, where the machine vision job is then interpreted and executed. Upon the execution of the machine vision job, output data generated by the imaging device 104 can be transmitted to the control computing device 103 for further analysis and use.

The user computing device 102 may comprise one or more operator computers or workstations, and may include one or more processors 108, one or more memories 110, a networking interface 112, an input/output (I/O) interface 114, and a smart imaging application 116.

The imaging device 104 is connected to the user computing device 102 via the network 106 or other communication means (e.g., a universal serial bus (USB) cable, etc.), and is configured to interpret and execute machine vision jobs received from the user computing device 102. Generally, the imaging device 104 may obtain a job file containing one or more job scripts from the user computing device 102 that define the machine vision job and may configure the imaging device 104 to capture and/or analyze images in accordance with the machine vision job. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture one or more images of the target object in accordance with the configuration established via the one or more job scripts. Once the image(s) are captured and/or analyzed, the imaging device 104 may transmit the image(s) and any associated data across the network 106 or other communication means (e.g., a USB cable, etc.) to the user computing device 102 for further analysis and/or storage. In various embodiments, the imaging device 104 may be a “smart” camera and/or may otherwise be configured to automatically perform sufficient functionality of the imaging device 104 in order to obtain, interpret, and execute job scripts that define machine vision jobs, such as any one or more job scripts contained in one or more job files as obtained, for example, from the user computing device 102.

Broadly, a job file may be a JSON representation/data format of the one or more job scripts transferrable from the user computing device 102 to the imaging device 104. The job file may further be loadable/readable by a C++ runtime engine, or other suitable runtime engine, executing on the imaging device 104. Moreover, the imaging device 104 may run a server (not shown) configured to listen for and receive job files across the network 106 or other communication means (e.g., a USB cable, etc.) from the user computing device 102. Additionally or alternatively, the server may be configured to listen for and receive job files may be implemented as one or more cloud-based servers, such as a cloud-based computing platform. For example, the server may be any one or more cloud-based platform(s) such as Microsoft Azure, Amazon Web Services (AWS), or the like.

In any event, the imaging device 104 may include one or more processors 118, one or more memories 120, a networking interface 122, an I/O interface 124, and an imaging assembly 126. The imaging assembly 126 may include a digital camera and/or digital video camera for capturing or taking digital images and/or frames. Each digital image and/or frame may comprise pixel data that may be analyzed by one or more tools each configured to perform an image analysis task. The digital camera and/or digital video camera of, e.g., the imaging assembly 126 may be configured, as disclosed herein, to take, capture, or otherwise generate digital images and, at least in some embodiments, may store such images in a memory (e.g., one or more memories 110, 120) of a respective device (e.g., the user computing device 102, the control computing device 103, the imaging device 104, etc.).

For example, the imaging assembly 126 may include a photo-realistic camera (not shown) for capturing, sensing, or scanning 2D image data. The photo-realistic camera may be an RGB (red, green, blue) based camera for capturing 2D images having RGB-based pixel data. In various embodiments, the imaging assembly 126 may additionally include a three-dimensional (3D) camera (not shown) for capturing, sensing, or scanning 3D image data. The 3D camera may include an Infra-Red (IR) projector and a related IR camera for capturing, sensing, or scanning 3D image data/datasets. In some embodiments, the photo-realistic camera of the imaging assembly 126 may capture 2D images, and related 2D image data, at the same or similar point in time as the 3D camera of the imaging assembly 126 such that the imaging device 104 can have both 2D image data and 3D image data available for a particular target, surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. Consequently, the captured 2D images and the corresponding 2D image data may be depth-aligned with the 3D images and 3D image data.

In embodiments, the imaging assembly 126 may be configured to capture images of surfaces or areas of a predefined search space or target objects within the predefined search space. For example, each tool included in a job script may additionally include a region of interest (ROI) corresponding to a specific region or a target object imaged by the imaging assembly 126. The composite area defined by the ROls for all tools included in a particular job script may thereby define the predefined search space which the imaging assembly 126 may capture in order to facilitate the execution of the job script. However, the predefined search space may be user-specified to include a field of view (FOV) featuring more or less than the composite area defined by the ROIs of all tools included in the particular job script. It should be noted that the imaging assembly 126 may capture 2D and/or 3D image data/datasets of a variety of areas, such that additional areas in addition to the predefined search spaces are contemplated herein. Moreover, in various embodiments, the imaging assembly 126 may be configured to capture other sets of image data in addition to the 2D/3D image data, such as grayscale image data or amplitude image data, each of which may be depth-aligned with the 2D/3D image data.

The imaging device 104 may also process the 2D image data/datasets and/or 3D image datasets for use by other devices (e.g., the user computing device 102, the control computing device 103, an external server, etc.). For example, the one or more processors 118 may process the image data or datasets captured, scanned, and/or sensed by the imaging assembly 126. The processing of the image data may generate post-imaging data that may include metadata, simplified data, normalized data, result data, status data, and/or alert data as determined from the original scanned and/or sensed image data. The image data and/or the post-imaging data may be sent to the user computing device 102 and/or the control computing device 130 executing the smart imaging application 116, 136 for viewing, manipulation, and/or otherwise interaction. In other embodiments, the image data and/or the post-imaging data may be sent to a server for storage or for further manipulation. As described herein, the user computing device 102, the control computing device 103, the imaging device 104, an external server or other centralized processing unit and/or storage may store such data, and may also send the image data and/or the post-imaging data to another application implemented on a user device, such as a mobile device, a tablet, a handheld device, a desktop device, etc.

The control computing device 130 may include one or more processors 128, one or more memories 130, a networking interface 132, and an I/O interface 134. The control computing device 103 may process image data and/or post-imaging data sensed, captured, processed and/or otherwise generated by the imaging device 104 to, for example, assist operators in a wide variety of tasks, track objects (e.g., moving on a conveyor belt past the imaging device 104), or any other tasks benefiting from or utilizing machine vision.

Example processors 108, 118, 128 include a programmable processor, programmable controller, microcontroller, microprocessor, graphics processing unit (GPU), digital signal processor (DSP), application specific integrated circuit (ASIC), programmable logic device (PLD), field programmable gate array (FPGA), field programmable logic device (FPLD), etc.

Each of the one or more memories 110, 120, 130 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, cache, or any other storage medium, device or disk in which information may be stored for any duration (e.g., permanently, for an extended time period, for a brief instance, for temporarily buffering, for caching of the information, etc.). In general, a computer program or computer based product, application, or code (e.g., a smart imaging application 116, 136 or other computing instructions described herein) may be stored on a computer usable storage medium, or tangible, non-transitory computer-readable medium (e.g., standard RAM, an optical disc, a USB drive, or the like) having such computer-readable program code or computer instructions embodied therein, wherein the computer-readable program code or computer instructions may be installed on or otherwise adapted to be executed by the one or more processors 108, 118, 128 (e.g., working in connection with a respective operating system (OS) in the one or more memories 110, 120, 130) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 110, 120, 130 may store an OS (e.g., Microsoft Windows, Linux, Unix, etc.) capable of facilitating the functionalities, apps, methods, or other software as discussed herein. The one or more memories 110, 130 may also store the smart imaging application 116, 136, which may be configured to enable machine vision job construction, as described further herein. Additionally and/or alternatively, the smart imaging application 116, 136 may also be stored in the one or more memories 120 of the imaging device 104, and/or in an external database (not shown), which is accessible or otherwise communicatively coupled to the user computing device 102 via the network 106 or other communication means. The one or more memories 110, 120, 130 may also store machine readable instructions, including any of one or more application(s), one or more software component(s), one or more user interface (UIs), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, UIs or APIs may be, include, otherwise be part of, a machine vision based imaging application, such as the smart imaging application 116, 136, where each may be configured to facilitate their various functionalities discussed herein. It should be appreciated that one or more other applications may be envisioned and executed by the one or more processors 108, 118, and 128.

The one or more processors 108, 118, 128 may be connected to the one or more memories 110, 120, 130 via a computer bus (not shown for clarity of illustration) responsible for transmitting electronic data, data packets, or otherwise electronic signals to and from the one or more processors 108, 118, 128 and the one or more memories 110, 120, 130 in order to implement or perform the machine readable instructions, methods, processes, elements or limitations, as illustrated, depicted, or described for the various flowcharts, illustrations, diagrams, figures, and/or other disclosure herein.

The one or more processors 108, 118, 128 may interface with the one or more memories 110, 120 via the computer bus to execute the OS. The one or more processors 108, 118, 128 may also interface with the one or more memories 110, 120, 130 via the computer bus to create, read, update, delete, or otherwise access or interact with the data stored in the one or more memories 110, 120, 130 and/or external databases (e.g., a relational database such as Oracle, DB2, MySQL, or a NoSQL based database such as MongoDB). The data stored in the one or more memories 110, 120, 130 and/or an external database may include all or part of any of the data or information described herein, including, for example, machine vision job images (e.g., images captured by the imaging device 104 in response to execution of a job script) and/or other suitable information.

The networking interfaces 112, 122, 132 may be configured to communicate (e.g., send and receive) data via one or more external/network port(s) to one or more networks or local terminals, such as the network 106, described herein. In some embodiments, networking interfaces 112, 122, 132 may include a client-server platform technology such as ASP.NET, Java J2EE, Ruby on Rails, Node.js, a web service or online API, responsive for receiving and responding to electronic requests. The networking interfaces 112, 122, 132 may implement the client-server platform technology that may interact, via the computer bus, with the one or more memories 110, 120, 130 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122, 132 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, the network 106 may comprise a private network or local area network (LAN). Additionally and/or alternatively, the network 106 may comprise a public network such as the Internet. In some embodiments, the network 106 may comprise routers, wireless switches, or other such wireless connection points communicating to the user computing device 102 (via the networking interface 112), the control computing device 103 (via the network interface 132) and the imaging device 104 (via networking interface 122) via wireless communications based on any one or more of various wireless standards, including by non-limiting example, IEEE 802.11a/b/c/g) (WiFi®), the Bluetooth® standard, near field communication (NFC), 3G, 4G, 5G, or the like.

The I/O interfaces 114, 124, 134 may include or implement operator interfaces configured to present information to an administrator or user/operator and/or receive inputs from the administrator or user/operator. An operator interface may provide a display screen (e.g., via the user computing device 102, the control computing device 103 and/or imaging device 104) which a user/operator may use to visualize any images, graphics, text, data, features, pixels, and/or other suitable visualizations or information. For example, the user computing device 102, the control computing device 103 and/or the imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124, 134 may also include I/O components (e.g., ports, capacitive or resistive touch sensitive input panels, keys, buttons, lights, light emitting diodes (LEDs), any number of keyboards, mice, USB drives, optical drives, screens, touchscreens, printers, etc.), which may be directly/indirectly accessible via or attached to the user computing device 102, the control computing device 130 and/or the imaging device 104. According to some embodiments, an administrator or user/operator may access the user computing device 102, the control computing device 103 and/or the imaging device 104 to construct jobs, review images or other information, make changes, input responses and/or selections, and/or perform other functions.

As described above herein, in some embodiments, the user computing device 102 and/or the control computing device 130 may perform the functionalities as discussed herein as part of a “cloud” network or may otherwise communicate with other hardware or software components within the cloud to send, retrieve, or otherwise analyze data or information described herein.

While example manners of implementing the user computing device 102, the control computing device 103 and the imaging device 104 are illustrated in FIG. 1, one or more of the structures and/or methods illustrated in FIG. 1 may be combined, divided, re-arranged, omitted, eliminated and/or implemented in any other way. Further still, the user computing device 102, the control computing device 103 and the imaging device 104 may include one or more structures or methods in addition to, or instead of, those illustrated in FIG. 1, and/or may include more than one of any or all of the illustrated structures and methods.

### Imaging Device

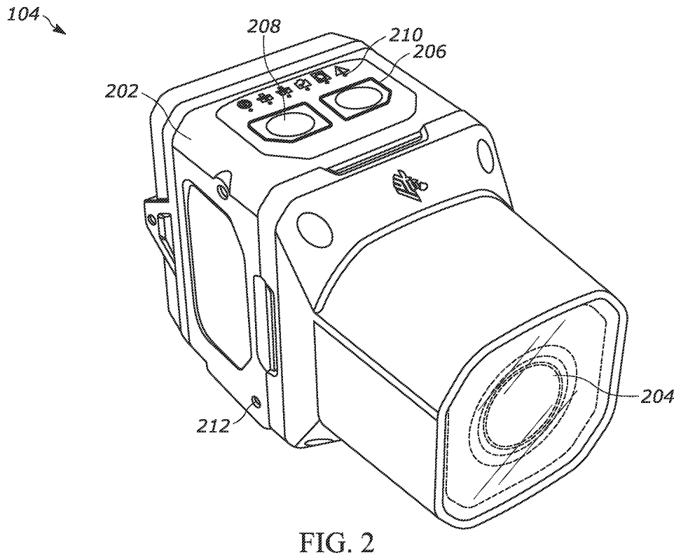

FIG. 2 is a perspective view of the imaging device 104 of FIG. 1, in accordance with embodiments described herein. The imaging device 104 includes a housing 202, an imaging aperture 204, a user interface label 206, a dome switch/button 208, one or more light emitting diodes (LEDs) 210, and mounting point(s) 212. As previously mentioned, the imaging device 104 may obtain job files from a user computing device (e.g., the user computing device 102) which the imaging device 104 thereafter interprets and executes. The instructions included in the job file may include device configuration settings (also referenced herein as “imaging settings”) operable to adjust the configuration of the imaging device 104 prior to capturing images of a target object.

For example, the device configuration settings may include instructions to adjust one or more settings related to the imaging aperture 204. As an example, assume that at least a portion of the intended analysis corresponding to a machine vision job requires the imaging device 104 to maximize the brightness of any captured image. To accommodate this requirement, the job file may include device configuration settings to increase the aperture size of the imaging aperture 204. The imaging device 104 may interpret these instructions (e.g., via the one or more processors 118) and accordingly increase the aperture size of the imaging aperture 204. Thus, the imaging device 104 may be configured to automatically adjust its own configuration to optimally conform to a particular machine vision job. Additionally, the imaging device 104 may include or otherwise be adaptable to include, for example but without limitation, one or more bandpass filters, one or more polarizers, one or more DPM diffusers, one or more C-mount lenses, and/or one or more C-mount liquid lenses over or otherwise influencing the received illumination through the imaging aperture 204.

The user interface label 206 may include the dome switch/button 208 and the one or more LEDs 210, and may thereby enable a variety of interactive and/or indicative features. Generally, the user interface label 206 may enable a user/operator to trigger and/or tune the imaging device 104 (e.g., via the dome switch/button 208) and to recognize when one or more functions, errors, and/or other actions have been performed or taken place with respect to the imaging device 104 (e.g., via the one or more LEDs 210). For example, the trigger function of a dome switch/button (e.g., the dome/switch button 208) may enable a user/operator to capture an image using the imaging device 104 and/or to display a trigger configuration screen of a user application (e.g., the smart imaging application 116). The trigger configuration screen may allow the user/operator to configure one or more triggers for the imaging device 104 that may be stored in memory (e.g., the one or more memories 120) for use in later developed machine vision jobs, as discussed herein.

As another example, the tuning function of a dome switch/button (e.g., the dome/switch button 208) may enable a user/operator to automatically and/or manually adjust the configuration of the imaging device 104 in accordance with a preferred/predetermined configuration and/or to display an imaging configuration screen of a user application (e.g., the smart imaging application 116). The imaging configuration screen may allow the user/operator to configure one or more configurations of the imaging device 104 (e.g., aperture size, exposure length, etc.) that may be stored in memory (e.g., the one or more memories 120) for use in later developed machine vision jobs, as discussed herein.

To further this example, and as discussed further herein, a user/operator may utilize the imaging configuration screen (or more generally, the smart imaging application 116) to establish two or more configurations of imaging settings for the imaging device 104. The user/operator may then save these two or more configurations of imaging settings as part of a machine vision job that is then transmitted to the imaging device 104 in a job file containing one or more job scripts. The one or more job scripts may then instruct the imaging device 104 processors (e.g., the one or more processors 118) to automatically and sequentially adjust the imaging settings of the imaging device 104 in accordance with one or more of the two or more configurations of imaging settings after each successive image capture.

The mounting point(s) 212 may enable a person to connect and/or removably affix the imaging device 104 to a mounting device (e.g., imaging tripod, camera mount, etc.), a structural surface (e.g., a warehouse wall, a warehouse ceiling, structural support beam, etc.), other accessory items, and/or any other suitable connecting devices, structures, or surfaces. For example, the imaging device 104 may be optimally placed on a mounting device in a distribution center, manufacturing plant, warehouse, and/or other facility to image and thereby monitor the quality/consistency of products, packages, and/or other items as they pass through the imaging device's 104 FOV. Moreover, the mounting point(s) 212 may enable a person to connect the imaging device 104 to a myriad of accessory items including, but without limitation, one or more external illumination devices, one or more mounting devices/brackets, and the like.

In addition, the imaging device 104 may include several hardware components contained within the housing 202 that enable connectivity to a computer network (e.g., the network 106). For example, the imaging device 104 may include a networking interface (e.g., the networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, NFC, Bluetooth, RS-232, and/or any other suitable communication protocol or combinations thereof.

### Machine Vision Application

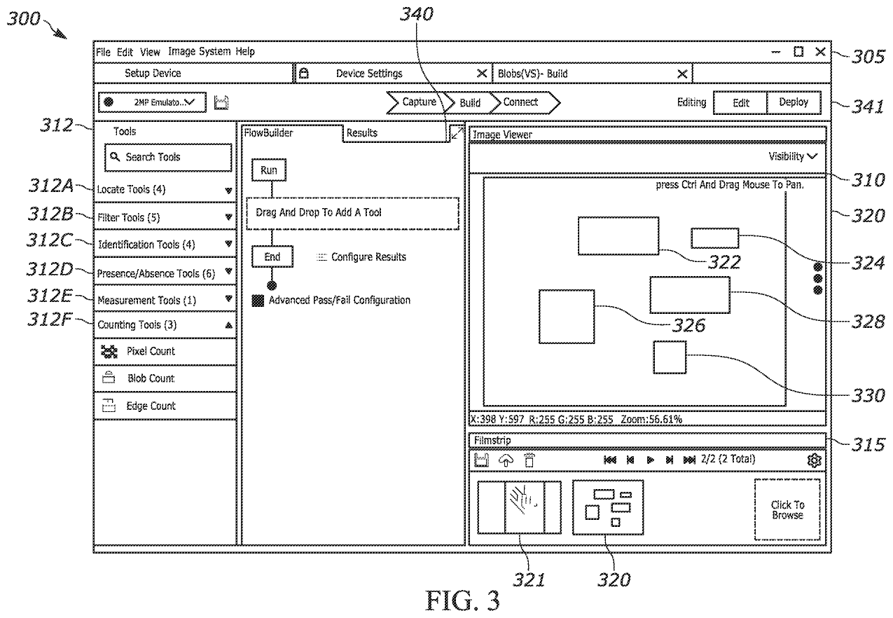

FIG. 3 depicts an example machine vision application 300 (e.g., the smart imaging application 116, 136) that may be utilized in connection with the control, configuration, operation, etc. of a machine vision system (e.g., the imaging device 104, etc.). The example machine vision application 300 includes a user interface 305 having a canvas 310 and a tool area 312. The canvas 310 may be a graphical working area for displaying, presenting, interacting with, manipulating, etc. digital images (e.g., selected from a filmstrip 315), regions of interest (ROIs), and targets in those regions of interest, in particular targets identified from analyzing the digital images based on selected tools. The images may be received from a machine vision system (e.g., the imaging device 104) and/or from a datastore of images. In the illustrated example of FIG. 3, the canvas 310 is in an edit mode and presenting a tool overlay image 320 generated by applying one or more tools a job script to an image 321 in the filmstrip 315. In particular, the application of the tool configuration parameters results in a region of interest (ROI).

The tool area 312 lists a plurality of different tools that will form part of a job scrip. These tools can be grouped by tool type, as illustrated, and include six (6) different example tool groupings: Locate Tools 312A, Filter Tools 312B, Identification Tools 312C, Presence/Absence Tools 312D, Measurement Tools 312E, and Counting Tools 312F. An example of the number of tools in each tool grouping is shown in parentheses. The Counting Tools 312F, for example, include three different tools: Pixel Count tool, Blob Count tool, and an Edge Count tool. In the illustrated example, the tool overlay image 320 was generated by applying the Blob Count tool to the image 321, as further described below. It will be appreciated that each of the tools in the tool area 312 may each result in their own respective tool overlay image 320, as each of the tools corresponds to different tool configuration parameters defining different conditions for image analysis. Further, as discuss below, multiple tools may be selected such that the image 321 is analyzed simultaneously by a group of tools, where that analysis will result in the tool overlay image 320. In the illustrated example of the Blob Tool, a job script having that tool selected is run on the image 321 and results in a five (5) different blobs satisfying the tool configuration parameters of the Blob Tool and thus 5 different blobs 322, 324, 326, 328, and 330 being identified by a fill box in the canvas 310. These blobs represent targets identified by a tool, applying its particular tool configuration parameters. For example, a Blob tool is one that identifies, as targets, uniform blobs of pixel intensity or uniform blobs of pixel color, where blob can refer to a geometric shape such as a rectangular or square or a formless shape. Other tools will identify other types of targets based on their respective tool configuration parameters.

In general, a machine vision job may be created (build), edited, etc. by defining one or more ROIs of an image and configuring their associated machine vision tools. When an ROI is selected, the machine vision application 300 may present a tool configuration user interface 340 that enables a user/operator to configure one or more of the machine vision tools (e.g., in the tool area 312) associated with the selected ROI. Once the machine vision job has been thus defined, the machine vision application 300 may deploy the machine vision job to a machine vision system (e.g., the imaging device 104, etc.), for example, as described above in connection with FIGS. 1 and 2, when an user/operator activates, presses, selects, etc. a “deploy” user interface feature 341. In some examples, an “edit” interface feature 343 may be provided to allow for editing in the build mode. FIG. 3 illustrates an example of the tool configuration user interface 340 that presents a user with a tool builder. In the illustrated example, the user is able to drag and drop one or more tools from the tool area 312 to the tool configuration user interface 340 to create a job script of tools. In various examples, tools that are dragged and dropped may be immediately executed on the image 321, which updates the tool overlay image 320.

### Example Auto-Configuring A Tool

To auto-configure a tool based on target metadata identified during a build mode, the machine vision application 300 may implement disclosed logic that allows a user to intuitively select a target having desired characteristics and automatically generate and apply metadata corresponding to those desired characters, which may then be deployed for execution during runtime on the machine vision system (e.g., the imaging device 104).

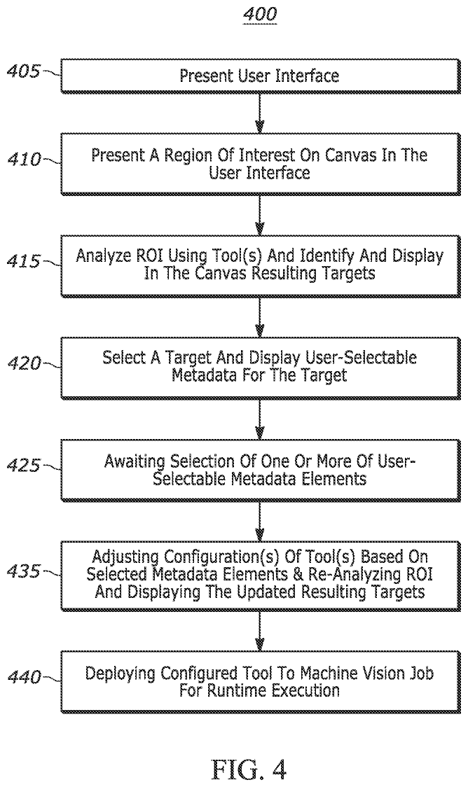

FIG. 4 is a flowchart 400 representative of example processes, methods, software, machine-readable instructions, etc. that may be carried out to performing auto-configuration of a tool that can be deployed into a machine vision job. The program 400 may be implemented during build mode, in which tools are configured and a job script of tools is built.

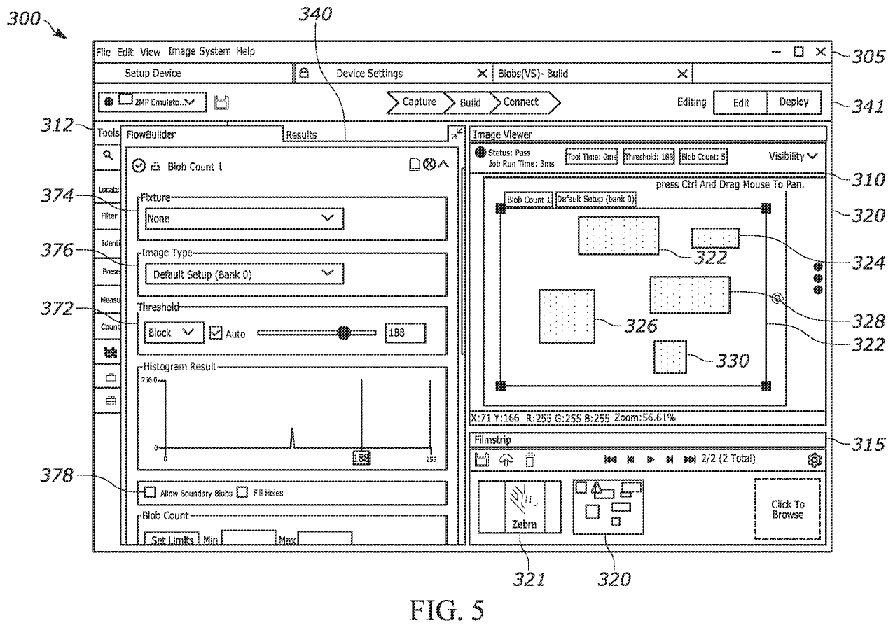

The program 400 of FIG. 4 begins at block 405 with a user interface of a machine vision application (e.g., the user interface 305 of the machine vision application 300) being presented on a display. One or more ROIs are presented on a canvas of the user interface (e.g., on the canvas 310), at a block 410. For example, a captured image may be displayed on the canvas and the block 410 may automatically identify a ROI in the image. For example, the block 410 may be configured to identify a ROI based on the location of the pixels forming the image data (e.g., the pixels over a region centered on the central pixel of the image data, or a ROI identified corresponding to pre-determined image characters that are identified at the block 410). In other examples, a user may manually select a ROI. FIG. 5 illustrates a ROI 332 that has been determined and displayed at the block 410.

The program 400 then analyzes (at block 415) the ROI 332 based on one or more selected tools, where these tools may be selected from the tool area 312 or where these tools may be automatically selected in other ways, e.g., by having a predetermined tool or set of tools that execute by default. The block 415 may access tool configuration parameters for the tools and analyze the image data applying those tool configuration parameters to identify targets in the image data that satisfy those parameters. The resulting targets in the ROI are displayed to the user at block 415. In the illustrated examples of FIGS. 4, 5, 6, and 7, the Blob tool has been applied to the image 321 resulting in the tool overlay image 320 in which the block 415 has identified and displayed targets 322, 324, 326, 328, and 330.

To auto-configure the tool or tools applied at block 415, a target is selected from among the displayed target (block 420). In some examples, the target is a user-selectable target that is selected by a user interacting with the canvas to click on one of the displayed targets. In some examples, the target may be automatically selected by the block 420. For example, at the block 420, the program 400 may assess image metadata for each identified target of block 415 and apply a statistical rule to select a representative target. For example, the target with the highest value for an image metadata element may be selected, e.g., the target with the largest area, the target with the largest major axis length, the target with the smallest minor axis length, or the target having an area or length closest to the mean area or length of all the targets.

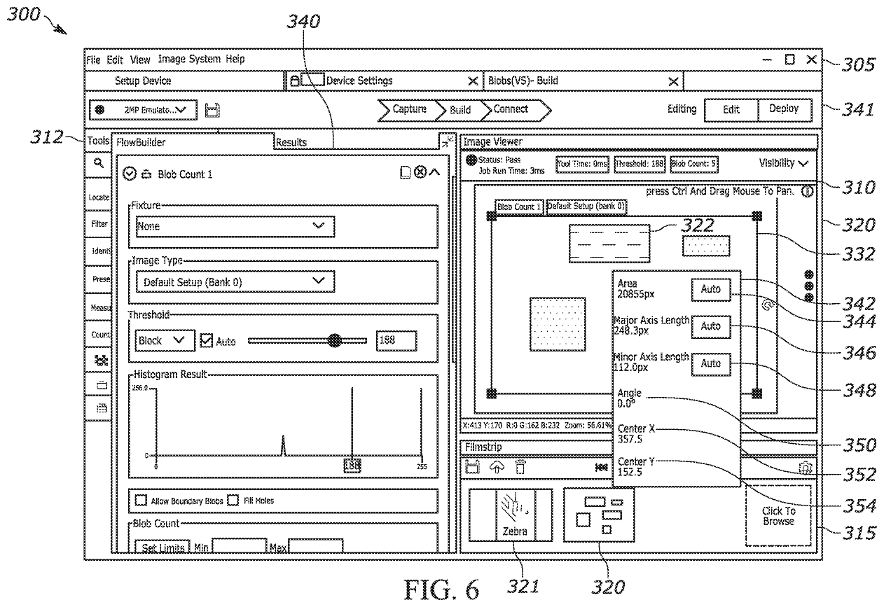

FIG. 6 illustrates the canvas 310, the overlay image 320, and the ROI 332 after the target 322 has been selected manually or automatically (block 420). In response to the selection, the program 400 determines the values of image metadata corresponding to the selected target. The image metadata will depend on the tool or tools and typically would correspond to some or all of the tool configuration parameters that define the tool. In the illustrated example of FIG. 6, the values for six (6) image metadata elements are determined for the target 322 and displayed in a menu 342. The 6 image metadata elements, each with determined values, are Area 344, Major Axis Length 346, Minor Axis Length 348, Angle 350, Center X position 352, and Center Y position 354. Of the image metadata elements displayed, three are user-selectable image metadata elements, 344, 346, and 348. The program 400, at the block 425, awaits a user to select one of these elements 344, 346, and 348, more specifically, in the illustrated example, a selection button (labeled “AUTO”) associated with the respective element.

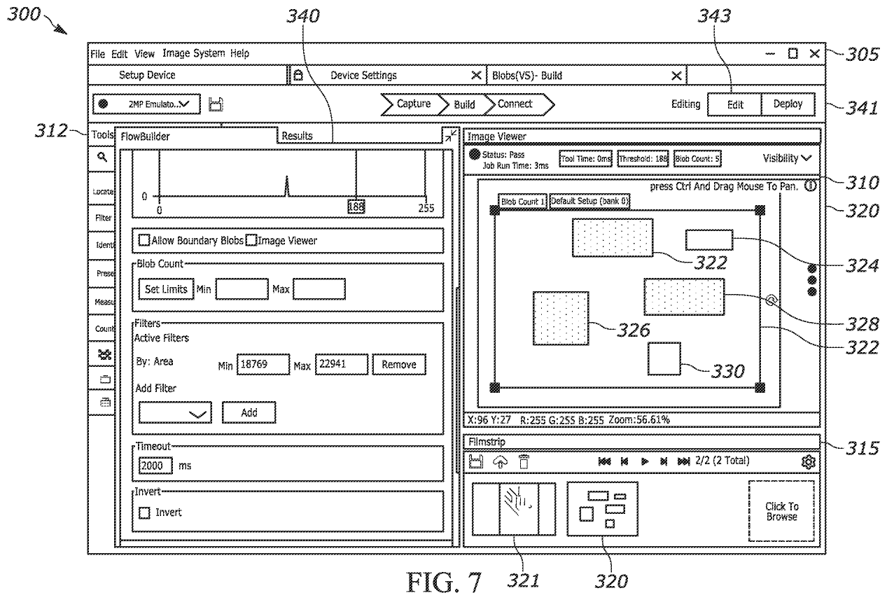

In response to selection of one of the user-selectable image metadata elements, a block 435 adjusts the configuration of the tools from block 415 to correspond to the values stored in the selected metadata elements. For example, the targets 322, 324, 326, 328, and 330 are initially identified (block 415) by satisfying an initial tool configuration parameter. After the selection, that initial tool configuration parameter is automatically re-configured. If the total Area metadata element 344 is selected, in some examples, an auto-configuration parameter is applied to value of the select metadata element corresponding to the selected target. In the illustrated example of FIG. 7, the selected Area metadata element 344 has a value of 20855 pixels, as the area. To auto-configure the Blob tool, the block 435 may then automatically set the maximum area of acceptable targets to be +5%, +10%, or +20% above the value 20855 pixels and automatically set the minimum area of acceptable targets to be −5%, −10%, or −20% below the value 20855 pixels. These values of +/−N% are auto-configuration parameters that are applied to the selected metadata element to automatically adjust tool configuration at the block (435). In some examples, the auto-configuration parameter is a percentage range parameter or a binary parameter. In some examples, the auto-configuration parameter represents a combination of auto-configuration parameters, each for revising a different metadata element.

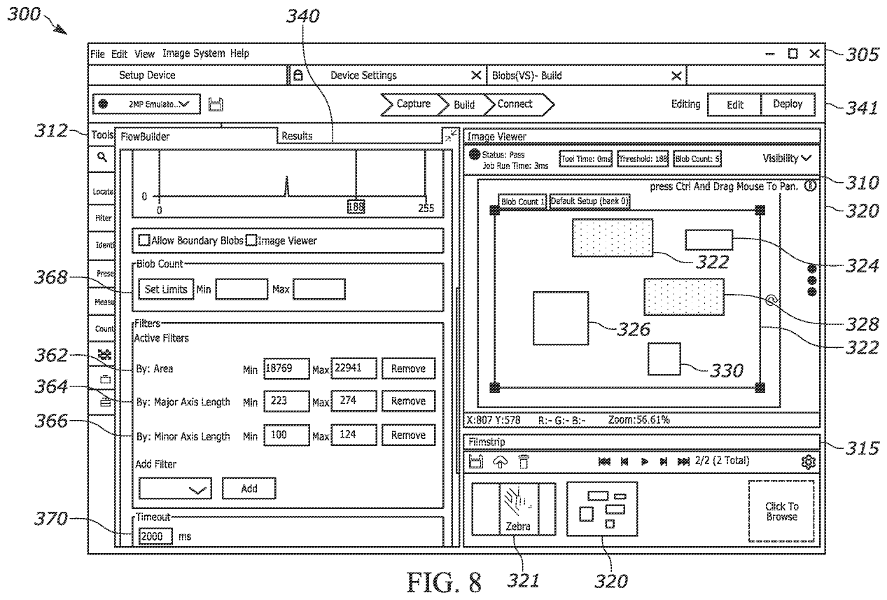

In response to the tool auto-configuration, in some examples, the block 435 re-analyzes the ROI 332 and displays an update resulting targets that satisfy the updated configuration, an example of which is shown in FIG. 7. In the illustrated example, in response to the user selecting image metadata element 344, additional targets 326 and 328 are highlighted in the canvas 310, showing that these additional targets satisfy the auto-configuration parameter, which in this example identifies any blobs having an area within +/−10% of the area of the target 322. That is, after the auto-configuration is performed, only three (3) of the initial five (5) targets are shown as satisfying the Blob tool with updated configuration. Now, the Blob tool will only look for blobs having an area similar to that of the target 322. FIG. 8 illustrates a resulting display of the user interface 305, where in addition to selecting the AUTO button of the Area image metadata element 344, the user has selected the AUTO button of the Major Axis Length image metadata element 346 is selected and the AUTO button of the Minor Axis Length image metadata element 348 is selected. With three elements selected, the block 435 applies a combination of auto-configuration parameters, e.g., a +/−10% range for each element, to the image 321 and more specifically over the ROI 332. The result, as shown in FIG. 8, is that only two blobs 322 and 328 now satisfy the combined criteria of the configured Blob tool.

The tool configuration user interface 340 that results from the selection at block 425 is shown in FIG. 8. Tool configuration parameters for Area 362, Major Axis Length 364, and Minor Axis Length 366 have been automatically updated by the block 435, with the corresponding value ranges shown. The user interface 340 thus allows a user to manually adjust the auto-configured tool configuration parameters if desired, for example, by manually entering in different min/max values. In some examples, the user interface 340 may include other Blob tool configuration parameters that, while not auto-configurable, can be manually determined. These include a Blob count min/max 368, a Timeout parameter 370 for ending the search for targets, a Threshold parameter 372 as shown in FIG. 5, a Fixture parameter 374, and Image type parameter 376. In some examples, tool configurations include display parameters 378, two of which are shown for the Blob tool in FIG. 5, Allow Boundary blobs and Fill holes.

After the tool or tools have been auto-configured, the updated tool may be deployed to a machine vision job for runtime execution (block 440).

While examples are described of performing auto-configuration of tool in response to selection of a target, in some examples, the program 400 may allow for selection of multiple targets. In some such examples, the image metadata elements displayed to the user may have values that have been aggregated for the selected targets. For example, the values may be the average of the values for each target. In some examples, the program 400 may be configured to allow user to select a portion of the ROI in the canvas that does not correspond to a target, e.g., the regions between targets. In some such examples, the program 400 may be configured to determine aggregated values of the image metadata elements for all targets initially identified by application of the tool. After one or more metadata elements are selected these aggregated values are then used with the auto-configuration parameter, such as a percentage range parameter or binary parameter, to identify only those targets corresponding to the re-configured tool.

The tool auto-configuration processes described herein, e.g., in FIG. 4, may be performed on any number of different machine vision tools, in particular any machine vision tool that identifies targeted image conditions, whether objects, portions of regions of interest, or image-derived features. Example machine vision tools are illustrated in the tool area 312. Yet others include edge detection tools and barcode detection tools, each having tools defined by different tool configuration parameters that may be auto-configured. An edge detection tool, for example, may allow a user to select a target edge identified in a ROI and auto-configure the edge detection tool based one or more image metadata elements. Example image metadata elements include angle of the target edge, length the target edge, the polarity of the target edge (e.g., whether the target edge is formed of a transition from left to right of dark pixels to light pixels or of light pixels to dark pixels), and shape of the edge (e.g., linear or curvilinear).

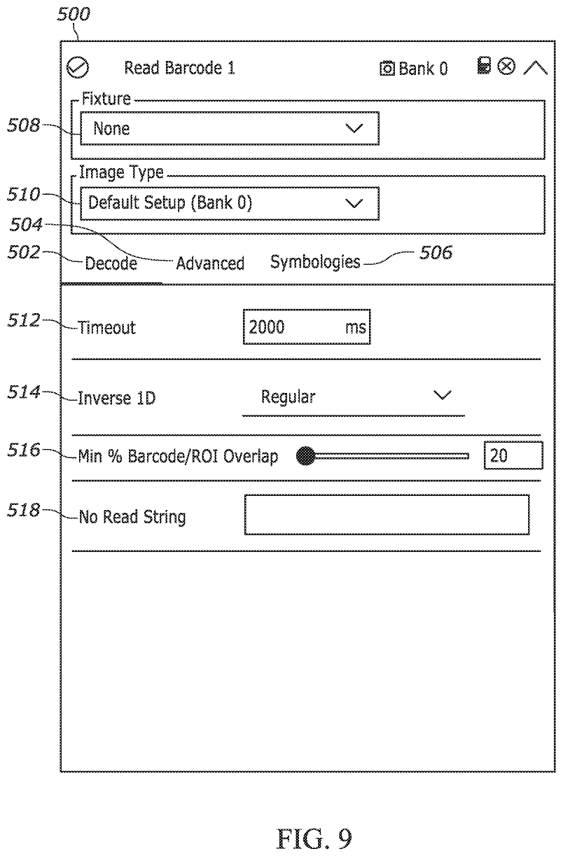

Other example machine vision tools include barcode detection tools. Indeed, in some examples, the present techniques may be implemented in barcode readers or other imaging devices and thus are not limited to machine vision devices. Barcode detection tools, for example, may allow for auto-configuration of tool configuration parameters, such as decoded string matches or other embedded data within a barcode. FIGS. 9-11 illustrate example barcode detection tools that may be auto-configured in accordance with examples processes herein. FIG. 9, for example, illustrates barcode tool configuration user interface 500 having three different barcode tool grouping tabs, a Decode grouping tab 502, an Advanced grouping tab 504, and Symbologies grouping tab 506. Further the user interface 500 may include a Fixture parameter 508 and Image type parameter 510.

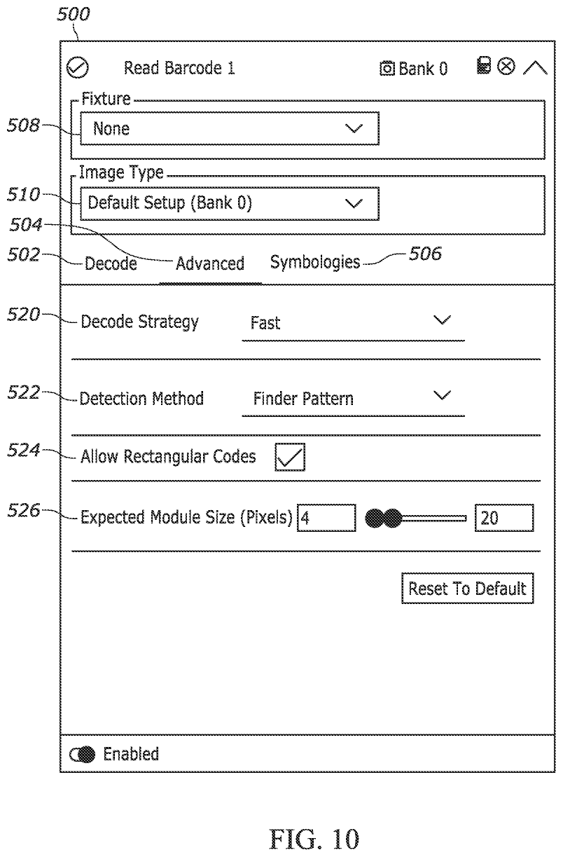

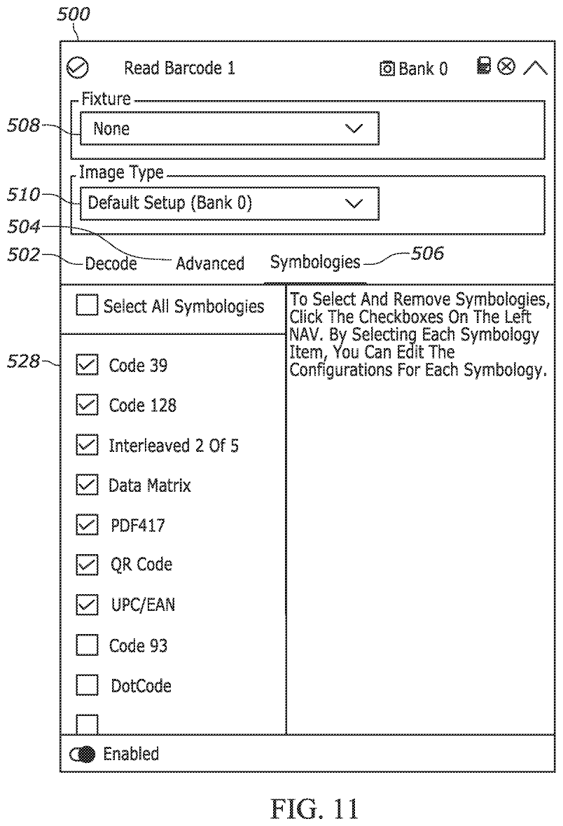

FIG. 9 illustrates an example of the expanded Decode grouping tab 502, while FIGS. 10 and 11 illustrate examples of the expanded Advanced grouping tab 504 and Symbologies grouping tab 506, respectively. As shown in FIG. 9, the Decode grouping may include a Timeout parameter 512, an Inverse ID parameter 514, a minimum % barcode/ROI overlap parameter 516, and a read string parameter 518. The parameter 516 for example may be auto-configured based on the percentage of overlap a selected target barcode displayed in a canvas of the user interface 500 (not shown). The barcode imaging device, for example, may determine the area of a selected target barcode and the percentage of that area that is within a ROI. Applying an auto-configuration parameter, such as a −/+5% or −/+10% to that percentage overlap, the parameter 516 may be auto-configured. The Barcode Detection Tool may be configured to search for certain predetermined strings in the decode data of a barcode or to search for strings in a predetermined location in the decode data, such as the first 3, 4, 5, 6, 7, or 8 bits of the decode data. Upon selecting a target barcode in a ROI, the processes herein may determine the value of the read string parameter 518 and indicate that to a user, allowing the user to select to auto-configure the Barcode tool to only identify barcodes that include that same value for the detected read string parameter.

FIG. 10 illustrates an example of the Advance grouping tab 504, showing a number of different tool configuration parameters. A decode strategy parameter 520 may be manually set by the user interacting with the user interface 500, e.g., selecting whether to a Fast decode as may be the case for job runs on standard image data or a Slow decode as may be needed for job runs on more complex image data, such as image data with numerous objects or numerous barcodes or poorer quality image data. Another manually determined parameter is a detection method 522, as well as whether to allow rectangular codes 524. By contrast, an example auto-configurable parameter is an expected module (pixel) size 526. This parameter may be manually set by a user through the user interface 500. However, the parameter 526 may be auto-configured from detecting a value thereof of a selected target barcode and using processes described herein. FIG. 11 illustrates the Symbologies grouping tab 506 having a symbology parameter 528, with multiple different values, each of which may be automatically detected in a target barcode and automatically set, through auto-configuration, as an acceptable symbology type using the processes here. In the illustrated example the symbology parameter 528 may be code 39, code 128, interleaved 2 of 5, data matrix, PDF417, quick response (QR) code, UPC/EAN, Code 93, or DotCode, merely by way of example. Indeed, as illustrated, tool auto-configuration techniques herein allow for multiple different tool configuration parameters to be set and for multiple different values for a single tool configuration parameter to set. For example, during a build phase, a user may be presented with an image having multiple different barcodes, each of a different barcode symbology. Or a user may be presented with multiple different images that have barcodes of different symbology within. A user may select each desired target barcode and select to have the parameter 528 updated to include the corresponding symbology type of each. Of course, in various embodiments, including that shown, the Barcode Detection tool may allow for manually selecting which of the symbology values are to be included in the Barcode Detection Tool by selecting a correspond button or a selected/deselect all symbologies button 530.

Yet, other Barcode Detection Tool configuration parameters include barcode parameters such as barcode type, e.g., 1D barcode or 2D barcodes, or the number of lines per barcode, or the pixels per module.

It should be appreciated that throughout this disclosure, references to input devices like a mouse should not be seen as limiting and other input devices should be considered to be within the scope of this disclosure. For example, it should be appreciated that in the event of a machine vision application being executed on a mobile device like a tablet or a notebook having touch-screen capabilities, a user's finger and the respective input functions via a screen may function just like the input functions of a computer mouse.

The processes, methods, software and instructions of FIG. 4 may be executable programs or portions of executable programs (e.g., the smart imaging application 116, 136) for execution by a processor such as the processor 108, 128. The programs may be embodied in software and/or machine-readable instructions stored on a non-transitory, machine-readable storage medium. Further, although example flowchart 400 is illustrated, many other methods of auto-configuring machine vision tools may alternatively be used. For example, the order of execution of the blocks may be changed, and/or some of the blocks described may be changed, eliminated, or combined. Additionally, or alternatively, any or all of the blocks may be implemented by one or more of a hardware circuit (e.g., discrete and/or integrated analog and/or digital circuitry), application specific integrated circuit (ASIC), programmable logic device (PLD), field programmable gate array (FPGA), field programmable logic device (FPLD), logic circuit, etc. structured to perform the corresponding operation(s) without executing software or instructions.

### Additional Considerations

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Further still, unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A method for auto-configuring a tool for one or more imaging device jobs, the method comprising:
displaying, by one or more processors via a display screen, an interactive graphical user interface (GUI) of an application, the application configured to generate job runs for the imaging devices in a job edit mode;
displaying, by the one or more processors within the interactive GUI, an image;
detecting, by the one or more processors, a selection of a region of interest (ROI) of the image;
analyzing, by the one or more processors, the ROI of the image using a tool to identify one or more targets in the image based on tool configuration parameters of the tool;
selecting a target among the one or more targets in the image and displaying user-selectable image metadata elements and result values of each element corresponding to the selected target;
selecting one or more user-selectable image metadata elements;
adjusting the tool configuration based on the user-selectable image metadata elements to generate revised tool configuration parameters for the tool; and
re-analyzing and displaying the ROI of the image using the tool with the revised tool configuration.

2. The method of claim 1, further comprising:
revising the job to include the tool with revised tool configuration; and
deploying the revised job to the imaging device for execution during a job runtime mode.

3. The method of claim 1, wherein each of the user-selectable image metadata elements corresponds to a different element in the tool configuration.

4. The method of claim 1, wherein adjusting the tool configuration based on the user-selectable image metadata elements comprises:
for each selected one or more user-selectable image metadata elements applying an auto-configuration parameter to automatic adjust the tool configuration.

5. The method of claim 4, wherein the auto-configuration parameter is a percentage range parameter or a binary parameter.

6. The method of claim 4, wherein the auto-configuration parameter represents a combination of auto-configuration parameters, each for revising a different element of the tool configuration.

7. The method of claim 4, the method further comprises for each of the one or more user-selectable image metadata elements displaying a current parameter value corresponding to the one or more targets and displaying a user selection button.

8. The method of claim 4, wherein the tool is a blob detection tool, and wherein analyzing the ROI of the image using the tool to identify the one or more targets in the image comprises:
identifying, as the one or more targets, uniform blobs of pixel intensity or pixel color.

9. The method of claim 8, wherein the one more user-selectable image metadata elements are selected from the group consisting of area, major axis length, and minor axis length.

10. The method of claim 8, wherein the tool configuration of the blob detection tool comprising area, major axis length, and minor axis length, axis, center X-axis position, and center Y-axis position.

11. The method of claim 4, wherein the tool is a barcode detection tool, and wherein analyzing the ROI of the image using the tool to identify the one or more targets in the image comprises:
identifying, as the one or more targets, one or more barcodes in the image.

12. The method of claim 11, wherein the one or more user-selectable image metadata elements comprises a barcode symbology type or a barcode percentage overlap in the ROI.

13. The method of claim 4, wherein the tool is an edge detection tool, and wherein analyzing the ROI of the image using the tool to identify the one or more targets in the image comprises:
identifying, as the one or more targets, one or more edges in the image.

14. The method of claim 13, wherein the one or more user-selectable image metadata elements comprises an edge angel, edge length, or edge polarity.

15. A system for auto-configuring a tool for one or more imaging device jobs, the method comprising:
a machine vision camera; and
a client computing device coupled to the machine vision camera, wherein the client computing device is configured to:
display, by one or more processors via a display screen, an interactive graphical user interface (GUI) of an application, the application configured to generate job runs for the imaging devices in a job edit mode;
display, by the one or more processors within the interactive GUI, an image;
detect, by the one or more processors, a selection of a region of interest (ROI) of the image;
analyze, by the one or more processors, the ROI of the image using a tool to identify one or more targets in the image based on tool configuration parameters of the tool;
select a target among the one or more targets in the image and display user-selectable image metadata elements and result values of each element corresponding to the selected target;
select one or more user-selectable image metadata elements;
adjust the tool configuration based on the user-selectable image metadata elements to generate revised tool configuration parameters for the tool; and
re-analyze and display the ROI of the image using the tool with the revised tool configuration.

16. The system of claim 15, wherein the client computing device is further configured to:
revise the job to include the tool with revised tool configuration; and
deploy the revised job to the imaging device for execution during a job runtime mode.

17. The system of claim 15, wherein each of the user-selectable image metadata elements corresponds to a different element in the tool configuration.

18. The system of claim 15, wherein the client computing device is further configured to adjust the tool configuration based on the user-selectable image metadata elements by:
for each selected one or more user-selectable image metadata elements applying an auto-configuration parameter to automatic adjust the tool configuration.

19. The system of claim 18, wherein the auto-configuration parameter is a percentage range parameter or a binary parameter.

20. The system of claim 18, wherein the auto-configuration parameter represents a combination of auto-configuration parameters, each for revising a different element of the tool configuration.

21. The system of claim 18, wherein the client computing device is further configured to for each of the one or more user-selectable image metadata elements display a current parameter value corresponding to the one or more targets and displaying a user selection button.

22. The system of claim 18, wherein the tool is a blob detection tool, and wherein the client computing device is further configured to analyze the ROI of the image using the tool to identify the one or more targets in the image by:
identifying, as the one or more targets, uniform blobs of pixel intensity or pixel color.

23. The system of claim 22, wherein the one more user-selectable image metadata elements are selected from the group consisting of area, major axis length, and minor axis length.

24. The system of claim 22, wherein the tool configuration of the blob detection tool comprising area, major axis length, and minor axis length, axis, center X-axis position, and center Y-axis position.

25. The system of claim 18, wherein the tool is a barcode detection tool, and wherein the client computing device is further configured to analyze the ROI of the image using the tool to identify the one or more targets in the image by:
identifying, as the one or more targets, one or more barcodes in the image.

26. The system of claim 25, wherein the one or more user-selectable image metadata elements comprises a barcode symbology type or a barcode percentage overlap in the ROI.

27. The system of claim 18, wherein the tool is an edge detection tool, and wherein the client computing device is further configured to analyze the ROI of the image using the tool to identify the one or more targets in the image comprises:
identifying, as the one or more targets, one or more edges in the image.

28. The system of claim 27, wherein the one or more user-selectable image metadata elements comprises an edge angel, edge length, or edge polarity.

29. A non-transitory machine-readable storage medium storing instructions that, when executed by one or more processors, cause a client computing device to:
display, by one or more processors via a display screen, an interactive graphical user interface (GUI) of an application, the application configured to generate job runs for the imaging devices in a job edit mode;
display, by the one or more processors within the interactive GUI, an image;
detect, by the one or more processors, a selection of a region of interest (ROI) of the image;
analyze, by the one or more processors, the ROI of the image using a tool to identify one or more targets in the image based on tool configuration parameters of the tool;
select a target among the one or more targets in the image and display user-selectable image metadata elements and result values of each element corresponding to the selected target;
select one or more user-selectable image metadata elements;
adjust the tool configuration based on the user-selectable image metadata elements to generate revised tool configuration parameters for the tool; and
re-analyze and display the ROI of the image using the tool with the revised tool configuration.
